(19) United States
(12) Patent Application Publication
(10) Pub. No.: US 2009/0296548 A1
(43) Pub. Date: Dec. 3, 2009

(54) METHOD FOR MEASURING AND OPTIMIZING RADIAL TO VERTICAL CROSSTALK

(75) Inventor: Edwin Johannes Maria Janssen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,440

(22) PCT Filed: Dec. 9, 2005
(86) PCT No.: PCT/IB2005/054160

§ 371 Date: Jun. 12, 2007

(30) Foreign Application Priority Data
Dec. 16, 2004 (EP) 04106629.1

(51) Int. Cl. G11B 27/36

(52) U.S. Cl. 369/53.13; G9B/27.052

(57) ABSTRACT

A method and system are provided, for reducing the amount of radial to vertical crosstalk in an error signal in an optical record carrier reader. The method comprises the steps of: measuring error signals in a plurality of error signal control loops of the reader, comprising a focus error signal control loop; calculating power dissipation in each error signal control loop for determining the amount of radial to vertical crosstalk in the focus error signal control loop. Countermeasures may be applied to the error signal control loops to minimize or optimize the radial to vertical crosstalk.

This invention pertains in general to the field of optical record carrier players. More particularly the invention relates to the effect of radial to vertical crosstalk on actuator steering in the optical record carrier player and more particularly to measuring the amount of radial to vertical crosstalk in a focus error signal and then minimizing or optimizing the radial to vertical crosstalk using counter-measures.

Different formats of optical recording medium including read-only optical discs, such as CD (Compact Disk), and DVD (Digital Versatile Disc); and recordable optical discs such as a CD-R (Compact Disc-Recordable), CD-RW (Compact Disc-Rewritable) and DVD+RW (Digital Versatile Disc+Rewritable) are well known. Also other record carriers are known which have a rectangular shape, i.e. credit card like record carriers. These optical record carriers may be written and/or read out by means of an optical pick up unit in an optical scanning device. The optical pick up units are mounted on a linear bearing for radially scanning across the tracks of the optical record carrier.

The optical scanning device comprises a light source such as a laser which is directed toward the optical record carrier. In addition to detecting and reading the information from the optical record carrier, the optical pick up unit also detects a variety of error signals, e.g., focus error, radial error and tracking error. These error signals are used by the optical scanning device to adjust various aspects of the scanning procedure to help reduce these errors. For example, the focus error signal can be used to determine how much the focus actuator should be steered to improve the focus of the laser.

Unfortunately, an optical phenomenon known as Radial to Vertical Crosstalk (RVC) or Radial to Focus Crosstalk (RFC) interferes with the error signals received by the optical pick up device. When the laser is on and the focus loop is closed but the radial loop is open, part of the radial error signal is seen in the focus error signal. This crosstalk in the focus error signal thus changes the actual value of the focus error. The focus actuator will then be steered based on erroneous error information. This non-desired focus actuator steering can result in a variety of problems. The erroneous steering may cause the focus actuator to operate for longer periods of time, thus increasing the power dissipation by the actuator. The power dissipation can result in saturation of the focus actuator driver's integrated circuits. The extra power dissipation results in extra heat production in the actuator and the driver. The erroneous focus movement can result in focus loss, during, for example, seek/sledge movements or radial open loop situations on high eccentricity discs. In addition, the de-focusing caused by the RVC causes the servo error signals to be strongly abberated. Finally, since many error signals need to be calibrated and optimized, e.g., radial initialization (scaling and offset removal of radial error signal), a high RVC results in non-optimally scaled error signals which adversely effects the operation of the optical scanning device.

Thus, there is a need for a method measuring and manipulating RVC. One known method for reducing RVC is to decrease the bandwidth of the focus position loop. This is not a desired solution as during radial open loop situations, mostly during a seek including high speed sledge movements, focus tracking should be keep. Furthermore, the amount of RVC created by the optical scanning device is dependent on each device. Deterioration of the optical pickup unit and the optical scanning device over the lifetime of the device and damp-heat cooldown-heatup situations introduce shifting of photodetectors, lenses, etc. These aberrations are inevitable and play a role in the amount of RVC each device creates. Hence, an improved method for measuring and optimizing the amount of RVC created by individual optical scanning device would be advantageous.

Accordingly, the present invention preferably seeks to mitigate, alleviate or eliminate one or more of the above-identified deficiencies in the art and disadvantages singly or in any combination and solves at least the above mentioned problems by providing a system, a method, and a computer-readable medium that measures and then minimizes or optimizes radial to vertical crosstalk according to the appended patent claims.

According to one aspect of the invention, a method is provided, for reducing the amount of radial to vertical crosstalk in an error signal in an optical record carrier reader. The method comprises the steps of: measuring error signals in a plurality of error signal control loops; calculating power dissipation in each error signal control loop which represents the amount of radial to vertical crosstalk in the focus error signal.

According to another aspect of the invention, a system is provided, for reducing the amount of radial to vertical crosstalk in an error signal in an optical record carrier reader. The system comprises: means for measuring error signals in a plurality of error signal control loops; and means for calculating power dissipation in each error signal control loop, representing the amount of radial to vertical crosstalk in focus error signal, said means being operatively connected to each other.

According to a further aspect of the invention, a computer-readable medium having embodied thereon a computer program for processing by a computer is provided. The computer program comprises code segments for reducing the amount of radial to vertical crosstalk in an error signal in an optical record carrier reader. The code segments comprise a first code segment for measuring error signals in a plurality of error signal control loops; and a second code segment for calculating power dissipation in each error signal control loop representing the amount of radial to vertical crosstalk in the focus error signal.

The present invention has at least the advantage over the prior art that it may measure the amount of radial to vertical crosstalk and then either minimize or optimize the radial to vertical crosstalk in the optical record carrier reader.

These and other aspects, features and advantages of which the invention is capable of will be apparent and elucidated from the following description of embodiments of the present invention, reference being made to the accompanying drawings, in which

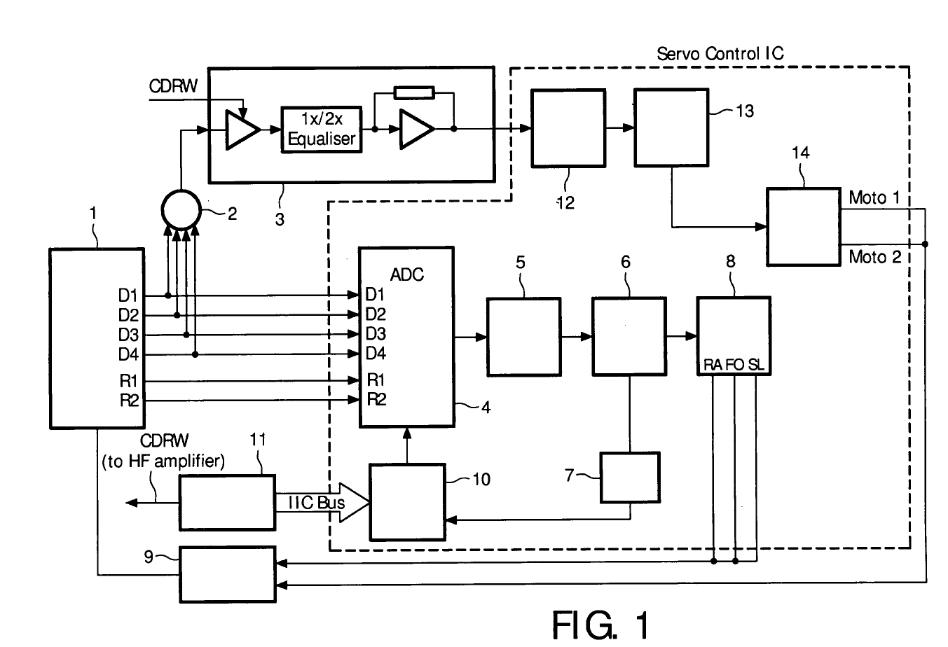

FIG. 1 is a block diagram of a servo control system of an optical disc player which incorporates the invention;

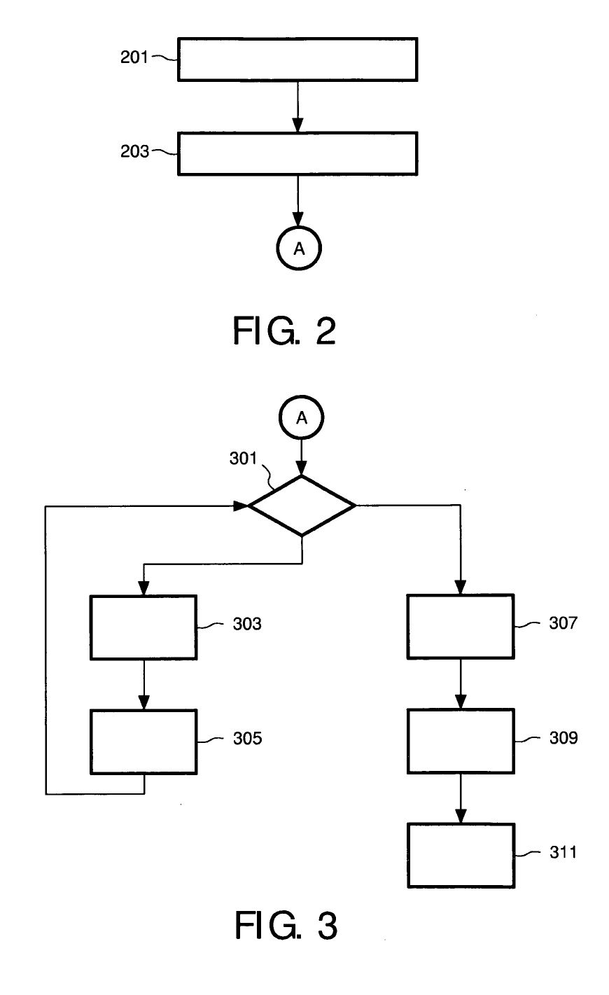

FIG. 2 is a flow chart illustrating a method for measuring radial to vertical crosstalk; and

FIG. 3 is a flow chart illustrating a method for minimizing or optimizing radial to vertical crosstalk.

The following description focuses on an embodiment of the present invention applicable to a optical disc player and in particular to an optical disc reader. However, it will be appreciated that the invention is not limited to this application but may be applied to many other optical scanning systems.

As shown in FIG. 1, the servo control system for an optical disc player according to one embodiment of the invention comprises a conventional laser mechanism 1 which contains an illuminating laser and associated optics for focussing the laser on the information surface of an optical disc. The laser mechanism 1 also includes appropriate detectors for detecting the radiation reflected from the disc in order to produce signals representing the data and indicating tracking of the information tracks. Also included is a motor for rotating the disc, means for focussing the laser radiation on selected portions of the disc under control of signals generated within the servo control system, and means for moving the reading head radially across the disc.

Four outputs D1-D4 from the laser mechanism 1 are summed in a summer 2 and fed to a high frequency amplifier 3. The four outputs D1-D4 together with two further outputs R1 and R2 are fed to an analogue to digital converter block 4, the output of which is passed to the pre-processing block 5 and then to a PID controller 6. A first output of the PID controller 6 is fed to a focus detector 7, while a second output is fed to an output stage 8. The power dissipation is measured at these outputs. This stage 8 produces outputs to control the focussing of the laser on the disc (FO), the fine radial positioning of the laser head on the disc (RA), and the sledge position (SL) which provides a coarse positioning of the read head with respect to tracks on the disc. The three outputs of the output stage 8 are fed through power amplifiers 9 to the laser mechanism 1. The output of the focus detector 7 is fed via an interface 10 to the controlling microprocessor 11.

The output of the amplifier 3 is fed to a front end circuit 12 which slices and converts the signal so that it is in the required form for application to a digital phase locked loop (DPLL) 13, an output of which is fed to a motor control circuit 14 which controls the speed of the spindle motor to cause the disc to be rotated at the desired speed for correct reading of the data from the disc. The output of the motor control circuit is fed through the power amplifiers 9 to the spindle drive motor. The controlling microprocessor 11 produces a signal that is arranged to vary the gain of the amplifier 3 according to whether a disc having high reflectivity, that is a CD Audio, CDROM, DVD, or the like, or a disc having a low reflectivity that is a CD-RW, BD, HD-DVD (AOD), etc or the like. Thus, the gain of the amplifier is increased when a low reflectivity disc is being played as the received signal will have a lower amplitude than one received from a high reflectivity disc. In addition the controlling microprocessor 11 increases the sensitivity of the analogue to digital converter block 4 to compensate for the lower levels of the signals D1-D4, R1 and R2. Thus far the servo control system is conventional and is constructed from well known circuit elements used in optical disc players.

FIG. 2 is a flow chart illustrating a method according to the invention for measuring radial to vertical crosstalk in an optical disc player. The method assumes that the laser mechanism 1 is on and the servo control system is reading the information from an optical disc.

The method shown in FIG. 2 is illustrated by a flow chart comprising the following illustrative blocks:

201 Measure error signals in a plurality of error signal control loops; and

202 Calculate power dissipation for each error signal control loop.

In step 201, error signals in a plurality of error signal control loops, e.g., focus, radial and tracking, are measured by the servo control system. For example, the measurements can be made and processed by the PID controller 6 and the controlling microprocessor 11. In step 203, the power dissipation of each error signal control loop can be calculated by applying the rules of power calculations. In this embodiment of the invention, the power dissipation of the focus error signal control loop is measured and represents the RVC, because the steering of the focus error signal control loop is based on this focus error signal. It will be understood that the power dissipation can be determined in a number of different known manners and the invention is not limited thereto.

FIG. 3 is a flow chart illustrating a method according to the invention for minimizing or optimizing RVC in an optical disc player. The power dissipation measurement of the focus error control loop may be used to minimize or optimize RVC.

The flow chart in FIG. 3 comprises the following blocks for illustrative purposes:

301 Decision: Minimize or optimize RVC?;

303 Apply countermeasures to the error signal control loops and calculate power dissipation for each countermeasure;

305 Fit second order curve to power dissipation values which represent the RVC to minimize RVC in focus error signal;

307 Apply plurality of countermeasures to error signal control loops;

309 Measure quality of signals in error signal control loops and calculate power dissipation for each countermeasure; and

311 select countermeasure value which minimizes the radial to vertical crosstalk which keeps the quality of the error signals above a predetermined value.

In step 301, it is first determined whether the system should minimize or optimize the RVC. This function can be selected by a user or determined by the controlling microprocessor based on a variety of criteria and data. If it is decided that the RVC should be minimized, a plurality of countermeasures are applied in the system in step 303. For example, a plurality of different focus error offset values or a plurality of focus loop gain values can be individually applied to the system. After each focus offset value or focus loop gain value is applied, a representation of the RVC is determined by measuring the power dissipation of the focus error control loop. In one embodiment of the invention, the focus offset or focus loop gain value which produces the smallest amount of represented RVC can then be selected as the focus offset or focus loop gain value which is used for a predetermined period of time. Alternatively, a second order curve can be selected to fit the represented RVC values in step 305.

However, the countermeasures added to countereffect the RVC may also deteriorate the quality of the other error signals. For example, if too much of a countermeasure is used, the RVC as well as other desired error signal may be minimized to the extent that even focus tracking is lost. Therefore, it may be desirable to limit the range of the countermeasures so that the quality of the other error signals does not fall below a predetermined threshold. Thus, the optimal countermeasure is a compromise between minimal RVC and reasonable quality of the signals to be measured. In step 301, if it is decided that the RVC should be optimized, a plurality of countermeasures are applied in the system in step 307. For example, a plurality of different focus offset values or a plurality of focus loop gain values can be individually applied to the system. After each focus offset value of focus loop gain value is applied, the resulting RVC is determined in the manner described above. In addition, the quality level of other signals such as error signals are also measured after each countermeasure is applied in step 309. The countermeasure which lowers the represented RVC the most while maintaining the signal quality of the error signals above the desired quality level, i.e. the represented RVC is optimized, is then selected, in step 311, to be used by the system for a predetermined period of time.

Applications and use of the above described method and apparatus according to the invention are various and include exemplary fields such as optical disc players and recorders.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described above with reference to (a) specific embodiment(s), it is not intended to be limited to the specific form set forth herein. Rather, the invention is limited only by the accompanying claims and, other embodiments than the specific above are equally possible within the scope of these appended claims, e.g. different uses than those described above.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A method for reducing the amount of radial to vertical crosstalk (RVC) in an error signal in an optical record carrier reader, said method comprising the steps of:
measuring error signals in a plurality of error signal control loops of the reader, comprising a focus error signal control loop; and
calculating power dissipation in each error signal control loop for determining the amount of radial to vertical crosstalk (RVC) in the focus error signal control loop of the reader.

2. The method according to claim 1, further comprising the step of applying countermeasures to the error signal control loops to minimize the radial to vertical crosstalk (RVC).

3. The method according to claim 1, further comprising the step of applying countermeasures to the error signal control loops to optimize the radial to vertical crosstalk (RVC).

4. The method according to claim 1, further comprising the steps of:
applying a plurality of countermeasures to the control loops;
measuring power dissipation of the focus error signal control loop, which represents the radial to vertical crosstalk (RVC), after each countermeasure is applied; and
selecting a countermeasure value which minimizes the radial to vertical crosstalk (RVC) for use in the optical record carrier reader.

5. The method according to claim 1, further comprising the steps of:
applying a plurality of countermeasures to the control loops;
measuring power dissipation of the focus error signal control loop, which represents the radial to vertical crosstalk (RVC), after each countermeasure is applied;
measuring quality of signals in the error signal control loops; and
selecting a countermeasure value which minimizes the radial to vertical crosstalk while keeping the quality of the signals above a predetermined value for use in the optical record carrier reader.

6. A system for reducing the amount of radial to vertical crosstalk (RVC) in an error signal in an optical record carrier reader, said system comprising:
means (6) for measuring error signals in a plurality of error signal control loops of the reader, comprising a focus error signal control loop;
means (11) for calculating power dissipation in a focus error signal control loop configured to determine the amount of radial to vertical crosstalk in the focus error signal control loop from the calculated power dissipation, said means (6, 11) being operatively connected to each other.

7. The system according to claim 6, further comprising means (11) for applying countermeasures to the error signal control loops configured to minimize the radial to vertical crosstalk.

8. The system according to claim 6, further comprising means (11) for applying countermeasures to the error signal control loops configured to optimize the radial to vertical crosstalk.

9. The system according to claim 6, further comprising:
means (11) for applying a plurality of countermeasures to the control loops;
means (6) for measuring power dissipation of the focus error signal control loop, which represents the radial to vertical crosstalk (RVC), after each countermeasure is applied; and
means (11) for selecting a countermeasure value which minimizes the radial to vertical crosstalk for use in the optical record carrier reader.

10. The system according to claim 6, further comprising:
means (11) for applying a plurality of countermeasures to the control loops;
means (6) for measuring power dissipation of the focus error signal control loop, which represents the RVC, after each countermeasure is applied;
means (6) for measuring quality of signals in the error signal control loops; and
means (11) for selecting a countermeasure value which minimizes the radial to vertical crosstalk while keeping the quality of the signals above a predetermined value for use in the optical record carrier reader.

11. A computer-readable medium having embodied thereon a computer program for processing by a computer, the computer program comprising code segments for reducing the amount of radial to vertical crosstalk (RVC) in an error signal in an optical record carrier reader, said code segments comprising:
a code segment for measuring error signals in a plurality of error signal control loops of said reader, comprising a focus error signal control loop;
a code segment for calculating power dissipation in each error signal control loop for determining the amount of radial to vertical crosstalk in the focus error signal control loop.

12. The computer readable medium according to claim 11, further comprising code segments for:
applying a plurality of countermeasures to the control loops;
measuring power dissipation of the focus error signal control loop, which represents the radial to vertical crosstalk (RVC), after each countermeasure is applied; and
selecting a countermeasure value which minimizes the radial to vertical crosstalk (RVC) for use in the optical record carrier reader.

13. The computer readable medium according to claim 11, further comprising code segments for:
applying a plurality of countermeasures to the control loops;
measuring power dissipation of the focus error signal control loop, which represents the radial to vertical crosstalk (RVC), after each countermeasure is applied; measuring quality of signals in the error signal control loops; and
selecting countermeasure value which minimizes the radial to vertical crosstalk while keeping the quality of the signals above a predetermined value for use in the optical record carrier reader.

14. Use of a measured or determined power dissipation of a focus error signal control loop in an optical record carrier reader for reducing the amount of radial to vertical crosstalk (RVC) in the reader.

15. An optical record carrier reader comprising the system according to claim 6.
